(19) United States
(12) Patent Application Publication
(10) Pub. No.: US 2024/0177924 A1
(43) Pub. Date: May 30, 2024

(54) COMPACT HIGH-VOLTAGE PULSE TRANSFORMER AND METHOD OF MANUFACTURING SAME

(71) Applicants: Yuriy Aleksandrovich GABLIYA, Moscow (RU); Yuriy Olegovich LADYAGIN, Moscow (RU)

(72) Inventors: Yuriy Aleksandrovich GABLIYA, Moscow (RU); Yuriy Olegovich LADYAGIN, Moscow (RU)

(21) Appl. No.: 18/577,464

(22) PCT Filed: Sep. 20, 2021
(86) PCT No.: PCT/RU2021/000405

§ 371 Date: Jan. 8, 2024

(30) Foreign Application Priority Data
Jul. 8, 2021 (RU) 2021120102

(51) Int. Cl. H01F 27/32; H01F 27/06; H01F 27/28

(52) U.S. Cl. CPC H01F 27/324; H01F 27/06; H01F 27/2828

(57) ABSTRACT

The invention relates to electrical engineering, technology for producing high voltages, portable devices for supplying a high voltage to ozonizers, ionizers, gas-discharge lamps and lasers, technology for producing nanosecond pulses, and primarily to output stage technology for electroshock devices. The technical result is reduced weight and dimensions, an improved manufacturing process and a reduced price. A high-voltage pulse transformer preferably comprises a secondary winding wound on a preferably removable support element, without a mandrel, frame, template or sleeve, in layers with insulation between said layers, and a primary winding separated from the secondary winding by insulation between the windings. The entire structure is potted with an electrical insulating compound or an electrical insulating liquid.

### TECHNICAL FIELD OF THE INVENTION

The invention relates to the technology for producing high voltages of electric current, portable devices for supplying a high voltage to ozonizers, ionizers, gas-discharge lamps and lasers, technology for producing nanosecond pulses, and primarily to output stage technology for electroshock weapons.

### BACKGROUND OF THE INVENTION

The traditional method of manufacturing high-voltage pulse transformers with or without a magnetic core consists in winding a lacquer-insulated winding wire in layers with interlayer insulation or winding it on a polymer, ceramic or electrocardboard, myco-fabric or another non-conductive mandrel or frame or template or sleeve, or winding it on a sectionalized non-conductive frame. The disadvantage of this method is the necessity to have a mandrel, a frame or a template or a sleeve having an outer diameter or a circumference diameter of the inscribed perimeter in tens and up to hundreds of winding wire diameters. Large winding diameter firstly does not allow to make a compact transformer for use in small-sized and microdevices using high voltage electric current for example in small-sized electroshock weapons and in particular electric bullets. Secondly, given the limited dimensions, this method does not allow the production of transformers with a large transformation ratio, and increased efficiency.

The traditional design of a high-voltage pulse transformer always contains a frame made of insulating material with primary and secondary winding wound on it, a magnetic core with a closed or non-closed magnetic core, with the secondary winding being made as a layer winding with single-layer winding of each layer and with interlayer insulation [1].

An example of a traditional design of a high-voltage pulse transformer is a transformer according to the patent [2], which contains an unclosed rod core (magnetic core) made of ferromagnetic material, primary and secondary windings, and a sealed housing.

As a rule, the switching circuit of a high-voltage pulse transformer for powering high-voltage devices contains a power source, such as a low-voltage accumulator or battery, a step-up voltage converter (inverter) and a threshold pulse shaping device in the circuit of the primary winding of the transformer, such as a semiconductor key (thyristor or transistor) or gas discharger of controlled or uncontrolled type, a discharge threshold or controlled element (protective arrester, thyratron). The high voltage pulses of a selected frequency generated on the secondary winding of the transformer are fed to the load.

The disadvantage of the considered transformer design is significant size and weight. Another disadvantage of transformers of the described design is their increased inductance, which is a consequence of the presence of a magnetic core in them.

The increased inductance of such transformers is an obstacle to obtaining short pulses for the operation of various short-pulse devices.

In portable high-voltage devices, the high-voltage transformer is the most massive and voluminous element and occupies up to ⅓ of the volume of the entire device in today's known serial designs, being at the same time the most massive component.

In electroshock weapons, one of the main characteristics is the “maximum developable no-load voltage” defined visually as “air penetration distance”. It is not possible to significantly reduce the dimensions of the above-described transformer while maintaining the described basic characteristic in such a design of a high-voltage pulse transformer.

There are coreless high-voltage transformers such as Tesla transformers [3], and other coreless transformers with the common name “air transformers”. Air transformers have a frame or frameless winding made of wire wound in the form of a spiral winding or as a rule with one or another pitch and a secondary winding on which a large number of turns of small diameter wire are laid in one layer on the frame winding. There is an air gap of several centimeters of air between the primary and secondary winding, even in small-sized Tesla transformers serving as inter-winding insulation, and the difference in diameter between the primary and secondary winding in air transformers can reach 3-5 times. Another version of the Tesla transformer has a primary winding, laid closely or with a gap turn to turn, but located only in the center of a very long with respect to the length of the primary winding of the frame-cylinder with the secondary winding.

Air transformers have a weak (not more than 0.1) inductive coupling between the coils, the reason for which is the need to have air insulation between the primary and secondary winding instead of solid or liquid thin-layer electrically strong insulation, having insignificant electrical strength and accordingly increased thickness to eliminate the possibility of spark electrical breakdown or leakage of high-voltage corona discharge between the windings.

A common disadvantage of air transformers is their very large size, which completely precludes the use of such transformers in portable high-voltage devices such as electroshock weapons. This disadvantage is a consequence of the inductive weak coupling due to the absence of a core and the weak magnetic permeability of the thick layer of air between the windings, as well as the very large distances between the windings and their suboptimal spatial arrangement for maximum inductive coupling.

These disadvantages are stated in source [4] where it is stated that the APT of the considered design: “can only be used for relatively small voltage increases”.

Weak coupling leads to a decrease in the no-load voltage or “air breakdown distance” of a Tesla-type transformer, although it is known that increasing the coupling coefficient by a factor of two only gives an increase in output voltage of 25%, and by a factor of four already 35%.

The source [4] describes the design of high-voltage air pulse transformers (APTs) without cores (magnetic system). These designs are characterized by large overall dimensions resulting from the fact that the average inner diameter or the diameter of the inscribed perimeter of the inscribed perimeter of the winding frames is hundreds and thousands of diameters of the winding wire, and the role of inter-winding insulation is performed by air having insignificant electrical strength at atmospheric pressure.

High-voltage pulse transformer without a core is chosen as a prototype [5]. The transformer contains a secondary winding wound without a frame but mostly with a sectional frame, the primary winding is separated from the secondary winding by a gap which is used as an electrical insulating material or a cylindrical tubular shell. The whole structure is placed in liquid, elastic or solid insulation electrical insulation. The transformer has the following disadvantages. The secondary winding, wound framelessly as a galette or cross winding (which, it is noted in the description of patent [5]), has negligible electrical strength due to the fact that the increment of potential from layer to layer of the winding wire must be withstood only by the lacquer insulation of the winding wire itself to prevent interlayer breakdown, which at small wire diameter (0.05-0.08) used in winding small-sized transformers has an electrical strength of only hundreds of volts in the presence of a potential of thousands of volts between the layers. Thus, the considered types of frameless winding do not have sufficient electrical strength reserve for operation and are prone to electrical breakdown. Winding of galette and cross-winding types requires special winding machines, fastening of wound coils with adhesives, which reduces the technological efficiency of winding. The layer-by-layer winding on a sectional frame at a small length of a section (and a section should have a length not more than 1.5-3 mm at execution of high-voltage pulse transformers) requires special winding machines allowing to spread the wire on the above-mentioned length at a high speed of winding. If such machines are not available, winding of a sectional coil with sections of the specified length is only possible in bulk. The transformer under consideration with a frame requires an additional separate part “frame” made by plastic molding and requires an accurate and expensive mold. The transformer also uses a tubular separating electrically insulating shell for the mutual isolation of the secondary and primary windings, which also requires an accurate and expensive mold. The self-sufficiency of molds is possible only in case of large-scale production of frames and shells. Transformers of the considered design without an electrically insulating shell are not technologically feasible. These disadvantages make the prototype transformer non-technological and expensive for limited series production. Winding made in bulk or galette and cross-winding method does not allow to achieve the maximum coupling coefficient of the transformer windings due to increased magnetic induction dissipation fluxes because of the impossibility to achieve the maximum density of winding laying. This increases the size of the transformer to achieve the required output voltage. However, in case of layer-by-layer winding of sections, the presence of press material between the sections of the sectional frame, the thickness of which cannot be less than 0.5-0.8 mm (for foreign-made injection molding machines and 1-1.5 mm for domestic-made injection molding machines), increases the volume of the transformer, reducing the connection between the windings and decreasing the efficiency of transformation.

The main disadvantage of the prototype is the limited number of windings in the transformer with the given outer dimensions at the given diameter of the winding wire of the prototype due to the fact that part of the volume is occupied by the “power axial rod” (so in the claims of the patent [4]). At the same time, based on the experience of manufacturing transformers according to the patent [5], it is known that the “power axial rod” made of the frame material and representing a part thereof cannot be made with a diameter of less than 3 mm, as the “power axial rod”, whose protruding (and cut after winding) ends are clamped in the spindles of the winding machine, breaks due to the large bending forces during winding of transformers, which makes winding of the transformer impossible.

### DISCLOSURE OF THE INVENTION

The technical problem is to create a method of manufacturing a small-size high-voltage pulse transformer without a magnetic core characterized by manufacturability, low cost of production with increased high no-load voltage, high transformer ratio and increased efficiency by improving the magnetic flux-circuit, reducing the magnetic induction dissipation fluxes. The technical problem is also to create a design of a transformer executable according to the claimed method.

The technical result consists in solving the said technical problems.

The specified technical result by the fact that the method of manufacturing a small-sized high-voltage pulse transformer without a magnetic core, containing the primary and secondary winding consists in that the secondary high-voltage winding is wound from the axis of the transformer on the winding removed after winding electrically conductive or left after winding non-electrically conductive support element with the minimum allowable bending radius of the winding enamel wire on the support element of 0.5-1.0 of the outer diameter of the winding wire, without mandrel, frame, template or sleeve, in layers turn to turn with separation of the wound layers of the winding enamel wire by interlayer insulation overlapping the length of the layers with an overlap, over the wound secondary winding lay a layer of interwinding insulation overlapping the length of layers with an overlap, and over the interwinding insulation wind the primary low-voltage winding and the entire wound structure is placed in liquid, elastic or curing electrical insulating material.

An additional feature of the method is that the supporting element is a wire or braided or single thread made of tear and twist resistant metal or polymer, carbon or mineral fiber and stretched between the spindle and the headstock of the winding machine.

An additional feature of the method is that the supporting element is a needle made of bend-resistant metal or polymer fixed in the spindle of the winding machine.

The specified technical result is also achieved by the fact that the small-sized high-voltage pulse transformer without a magnetic core, containing a primary single-layer or multi-layer low-voltage and secondary high-voltage multi-layer winding with interlayer insulation, has an axial channel of the secondary winding filled with electrical insulating material or compound, over the secondary winding laid interwinding layer insulation on top of which is wound primary low-voltage winding, the electrical insulating material or compound winding so that the winding is filled with electrical insulating material or compound.

An additional feature of the transformer is that it has a first layer of interlayer insulation made of an adhesive single-sided or double-sided insulating film.

An additional feature of the transformer is that it is completely filled with high-voltage electrical insulating material or compound filling the axial channel, the free spaces between the layers of interlayer and interwinding insulation and covering the outer surface of the wound transformer, and the winding leads come out of the outer surface of the electrical insulating material or compound.

An additional feature of the transformer is that one of the leads of the high-voltage secondary winding is connected to the lead of the primary winding within the compound fill without extending outwardly from the surface of the fill.

An additional feature of the transformer is that it has a primary multi-layer trapezoidal low voltage winding with a lower base of the trapezoidal winding facing the secondary winding.

An additional feature of the transformer is that one of the leads of the primary or secondary winding passes in an axial channel within the primary or secondary winding.

An additional feature of the transformer is that one of the leads of the high-voltage secondary winding is connected to the lead of the primary winding within the electrical insulating material or compound fill.

### BRIEF DESCRIPTION OF THE DRAWINGS

FIG. 1 Sectional View of the Transformer.

### EXECUTION OF THE INVENTION

The secondary wire winding is wound without the initial insulation layer on a supporting element in the form of a super-strong polyaramid or ultra-high molecular weight polyethylene or carbon or mineral (e.g. fiberglass) wire or filament stretched between the spindle and the headstock of the winding machine and rotating together with the spindle and the headstock. Or it is wound without the initial layer of insulation on a steel needle clamped in the spindle of a winding machine. Modern winding wire of small diameters in lacquer insulation (enamel wire) allows bending radius from 0.5 to 1.0 of its diameter without breaking the integrity of insulation that allows to use in the claimed transformer winding wires of required diameter for high-voltage pulse transformers of small-sized electroshock devices (0.05-0.12 mm). The multiple layers of the secondary winding are wound in a single layer using interlayer and interwinding insulation overlapping the length of the layers and the diameter of the layers of the enamel wire with an overlap according to the usual rules of winding of high-voltage transformers. It is obvious to the skilled person that the said winding method is most easily achieved by winding the first layer of winding wire in varnish insulation on a metal wire or carbon filament or non-conductive polymer or mineral filament stretched between the spindle and the rotating tailstock of the winding machine, and pulling this wire or filament out of the axial space (channel) of the wound transformer after it has been wound. Conductive wire or filament is pulled out of the axial space of the transformer after it has been wound. Non-conductive polymer or mineral filaments can be removed from the axial space of the wound transformer and simply cut off at the ends of the wound transformer, but this method is less practical (see below).

After winding the secondary winding, the winding is covered with layers of inter-winding insulation on top of which the primary low-voltage winding is wound with thick wire with a small number of turns, usually in a single layer. The wound transformer is placed in a liquid electrical insulating material (including melt, for example, of polymers, for example, polyethylene) or compound and cured by cooling or polymerization mainly under vacuum or pressure or combining both methods (first vacuum and then pressure). In this case, the axial channel formed by pulling out of the axial space of the conductive wire or filament is filled with electrical insulating material or compound, and the free spaces between the layers of interlayer and interwinding insulation are also filled. When using a non-wire filament, the electrical insulating material or compound fills mainly the free spaces between the layers of interlayer and interwinding insulation, but also penetrates into the axial space. It is much more reasonable to pull the carrier out of the axial space in order to fill the axial space completely with electrical insulating material, because if even a non-conductive carrier is left in the axial space, there is a possibility of the electrical insulating material not flowing between the carrier and the first winding layer with the subsequent possibility of electrical breakdown of the first layer due to the potential difference between the beginning of the layer and the end of the layer. But in any case, the axial channel after winding of the transformer is filled with electrical insulating material, whether it is drawn (filling with curing material) or left to the carrier element (electrical insulator in the form of filament).

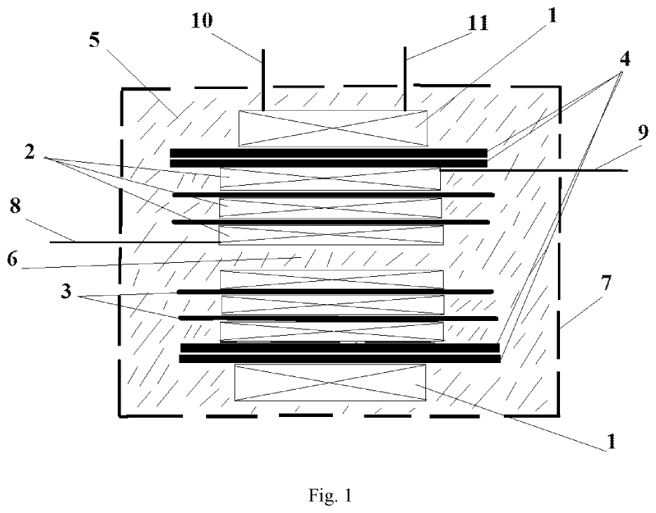

FIG. 1. The transformer without a magnet core has primary 1 and secondary 2 windings, inter-winding insulation 3 and inter-layer insulation 4 and is placed in a fusible or curable electrical insulating material or compound 5, and it completely fills and axial space 6 in the axis of the transformer when, as described in the method above, a supporting element in the form of a thin conductive needle comparable in diameter to a filament or wire, wire or filament is removed from the transformer. The transformer may be hull-less (filled with an electrically insulating material or compound 5 in a mold with subsequent removal from the mold after curing of the material), but may also have an outer power housing 7. The secondary winding of high-voltage transformers is made of thin enamel wire having leads 8 and 9, the primary low-voltage winding having leads 10 and 11 can be made of thick enamel wire as well as of various types of assembly wire (e.g. MGTEF, MS and the like) with extruded or sintered polymer insulation.

The first layer wound on the forming support element is preferably separated from the subsequent second layer of the winding wire by an interlayer insulation made of a film with high electrical strength, such as astralon, kapton (e.g. adhesive kapton), fluoroplastic, polyethylene terephthalate and etc. with overlapping of the ends of the film and a separation from both ends of the laid layer of winding wire, adhesive single-sided or double-sided insulating film. In this case, one side of the film with the adhesive applied to it must be adjacent to the first layer of the secondary winding. While it is theoretically possible that the first insulation layer can be made of these types of film without an adhesive layer, pulling the support element out of the axis space of the wound transformer will usually cause the wound transformer to be disassembled. When the support element is pulled out of the wound transformer, gluing the first layer of the interlayer insulation film to the first winding layer does not prevent the entire first winding layer from being pulled out of the transformer if conventional interlayer insulation films are used for the subsequent interlayer insulation or if the layers are loosely wound. All subsequent layers of interlayer insulation after the first winding layer can be made of the specified film material without an adhesive layer. Thickness of one layer of interlayer insulation when using modern electrical insulating polymer films with high electrical strength from the specified materials does not exceed 20-60 microns. Due to the low thickness of the interlayer insulation layers, high density (filling) of the transformer volume with wire windings is achieved. The coupling coefficient of the windings of the claimed transformer is maximized due to the reduction of magnetic induction dissipation fluxes, achieved by the high density of the secondary winding with the maximum possible convergence of the primary and secondary windings. The primary low-voltage winding is usually wound on top of the secondary winding through an interwinding insulation made of the specified insulating film material. However, the winding order can also be changed if necessary. The low-voltage primary winding of one or more layers with or without insulation between the layers is first wound on the winding support element. On the primary winding, a high-voltage secondary winding of multiple layers with interlayer insulation is wound through the interwinding insulation. However, it is more appropriate to wind the primary winding of thick wire over the secondary winding of thin wire, since thin wire always has a smaller radius of the minimum bending allowed by the technical specifications, and due to the small unused axial space, it makes it possible to laying more layers (and turns) of the secondary winding at a given outer diameter of the transformer and thus increase the transformer's coefficient of transformation. The primary winding can be both single and multilayer due to the small number of turns of large diameter wire to obtain a large transformer coefficient, and in particular, when winding over the secondary winding trapezoidal with the lower base of the trapezium facing the secondary winding, such trapezoidal primary winding in possibly necessary cases of transformer application increases the duration of the high-voltage pulse compared to cylindrical winding with the same number of turns. The thickness of the inter-winding insulation electrically separating the primary and secondary windings does not exceed 60-200 μm. After winding, the transformer is either removed from the electrically conductive supporting element (carbon fiber, metal wire or needle by pulling (removing) the fiber, wire or needle from the formed axial opening of the transformer) or in case of winding on a non-conductive supporting element (polymer filament, mineral fiber), the supporting element is removed by pulling or left inside the axial space and the ends of the supporting element are cut at the ends of the transformer, which is less expedient (indicated above in the description of the method). After that, under vacuum or pressure or combining vacuum and pressure, the transformer is filled in the mold with electrical insulating material or compound 5 followed by curing of the material and removal of the finished transformer from the mold. During the filling process, the material 5 also fills the free spaces between the layers of interlayer insulation at the ends of the transformer. The electrical insulation material can be either flexible or inelastic (e.g. polyethylene, paraffin, curing silicone or epoxy compound). It is also possible to pour the electrical insulating material into the housing 7 in which the wound transformer is placed. In this case, the mold for filling is not required, and the housing 7 made mainly of polymer material gives the transformer additional mechanical strength and better electrical insulation properties. It is possible to use non-curing electrical insulating materials (e.g. silicone or transformer oils) for the construction of the hermetically sealed housing 7 and hermetically sealed leads of the secondary and primary windings of the transformer.

When manufacturing transformers with the number of winding layers calculated to obtain the required transformation ratio, it is often necessary to bring the ends of the secondary winding to one side of the transformer. In the claimed transformer, one of the leads of the secondary winding 2, when winding the first layer of the secondary winding on the initial layer of insulation placed on the support member, can be passed through the axial channel after removal of the support member to exit the high-voltage lead to the other side of the transformer. The lead is pulled through a thin electrical insulating tube placed in the axial space in place of the carrier element after it is removed from the axial space 7 of the transformer.

In one embodiment of the transformer, one of the leads of the high-voltage secondary winding adjacent to the inter-winding insulation is connected to the lead of the primary winding directly inside the compound filling 5 without the lead going out, and thus the transformer has only two low-voltage leads going out of the compound filling 5 or out of the housing 7, and one high-voltage lead going out of the axial space of the transformer. Such a design is convenient for many topologies of electroshock weapon termination stages.

In the claimed transformer design, the coupling coefficient of the transformer windings is increased by reducing the magnetic induction dissipation fluxes achieved by maximum convergence of the primary and secondary windings and increased density of the secondary winding. Because of the reduced inductance due to the absence of a magnetic core, the transformer can be used in short pulse high voltage applications.

In the description it is stated that the invention relates mainly to the technique of terminating stages of electroshock devices. The novelty of the quality consists in the fact that on the basis of the claimed transformer invention for the first time in the world it was possible to create a full-fledged small-size contact remote-acting electroshock weapon [6].

The proposed difference in the design of the high-voltage transformer, which consists in winding the high-voltage transformer without a magnet core at the minimum permissible bending radius of the wire, which is currently at the existing today quality and technology of applying lacquer insulation is 0.5-1.0 outer diameter of the winding wire are not obvious to specialists in high-voltage technology and the technique of electroshock weapons, to which technique, as indicated in the description of the invention, the invention mainly relates, and are not obvious to specialists in high-voltage technology and electroshock weapons. In the future, however, it is likely that wire lacquer coatings will be developed which will permit a bending radius of the winding wire even less than 0.5 of its outer diameter.

In the claimed transformer design, the coefficient of current and coupling coefficient of the transformer windings is maximized for transformers without a magnetic core due to the reduction of magnetic induction dissipation fluxes achieved by the maximum convergence of the primary 1 and secondary 2 windings and the following corresponding reduction of their diameter and length.

### LIST OF CITED SOURCES

1. G. V. Gerashchenko. Reference Guide for Manufacturing of Transformer Coils (1956)
2. U.S. Pat. No. 6,810,868B2
3. US No. 568176
4. S. S. Vdovin. Designing of Pulse Transformers. Energoatomizdat, 1991, pp. 194-198.
5. RU No. 2482562.
6. RU No. 2744303

1. The method of manufacturing small-sized high-voltage pulse transformers without a magnetic core, containing the primary and secondary winding consists in that the secondary high-voltage winding is wound from the axis of the transformer on the winding removed after winding electrically conductive or left after winding non-electrically conductive support element with the minimum allowable bending radius of the winding enamel wire on the support element of 0.5-1.0 of the outer diameter of the winding wire, without mandrel, frame, template or sleeve, in layers turn to turn with separation of the wound layers of the winding enamel wire by interlayer insulation overlapping the length of the layers with an overlap, over the wound secondary winding lay a layer of interwinding insulation overlapping the length of layers with an overlap, and over the interwinding insulation wind the primary low-voltage winding and the entire wound structure is placed in liquid, elastic or curing electrical insulating material.

2. The method according to item 1, characterized in that the supporting element is a wire or braided or single thread made of tear and twist resistant metal or polymer, carbon or mineral fiber and stretched between the spindle and the headstock of the winding machine.

3. The method according to item 1, characterized in that the supporting element is a thin needle made of bend-resistant metal or polymer fixed in the spindle of the winding machine.

4. The small-sized high-voltage pulse transformer without a magnetic core, containing a primary single-layer or multi-layer low-voltage and secondary high-voltage multi-layer winding with interlayer insulation, differing in that it has an axial channel of the secondary winding filled with electrical insulating material or compound, over the secondary winding laid interwinding layer insulation on top of which is wound primary low-voltage winding, the electrical insulating material or compound winding so that the winding is filled with electrical insulating material or compound.

5. The transformer according to item 4, characterized in that it has a first layer of interlayer insulation made of an adhesive single-sided or double-sided insulating film.

6. The transformer according to item 4, characterized in that it is completely filled with high-voltage electrical insulating material or compound filling the axial channel, the free spaces between the layers of interlayer and interwinding insulation and covering the outer surface of the wound transformer, and the winding leads come out of the outer surface of the electrical insulating material or compound.

7. The transformer according to item 4, characterized in that one of the leads of the high-voltage secondary winding is connected to the lead of the primary winding within the compound fill without extending outwardly from the surface of the fill.

8. The transformer according to item 4, characterized in that it has a primary multi-layer trapezoidal low voltage winding with a lower base of the trapezoidal winding facing the secondary winding.

9. The transformer according to item 4, characterized in that one of the leads of the primary or secondary winding passes in an axial channel within the primary or secondary winding.

10. The transformer according to item 4, characterized in that one of the leads of the high-voltage secondary winding is connected to the lead of the primary winding within the electrical insulating material or compound fill.
